(19) United States
(12) Patent Application Publication
(10) Pub. No.: US 2008/0086679 A1
(43) Pub. Date: Apr. 10, 2008

(54) DATA STRUCTURE FOR DEFINING A CHART

(75) Inventors: Paul Gazzillo, Titusville, NJ (US); Phillip Leung, Columbus, NJ (US)

Correspondence Address: MAYER BROWN LLP, P.O. BOX 2828, CHICAGO, IL, 60690, US

(73) Assignee: Educational Testing Service, Princeton, NJ (US)

(21) Appl. No.: 11/867,578

(22) Filed: Oct. 4, 2007

Related U.S. Application Data
(60) Provisional application No. 60/828,248, filed on Oct. 5, 2006.

(51) Int. Cl. G06F 15/00

(52) U.S. Cl. 715/224

(57) ABSTRACT

This application discloses an invention that is related, generally and in various embodiments, to a data structure for defining a chart.

This application claims priority to U.S. Provisional Application Ser. No. 60/828,248 filed Oct. 5, 2007, the entire contents of which is hereby incorporated by reference herein.

### BACKGROUND OF THE INVENTION

This application discloses an invention that is related, generally and in various embodiments, to a data structure for defining a chart.

A data structure is a way of storing data in a computer so that it can be used efficiently. It can be viewed as an interface between two functions or as an implementation of methods to access storage that is organized according to the associated data type. Different kinds of data structures are suited to different kinds of applications, and some are highly specialized to certain tasks.

For many applications, very specific charts are utilized to present data. A chart is a type of information graphic or graphic organizer that represents tabular numeric data and/or functions. Charts are often used to make it easier to understand large quantities of data and the relationship between different parts of the data. Charts can usually be read more quickly than the raw data that they come from. In general, it is relatively difficult for third-party vendors to produce such charts to present data, oftentimes complicated formatted data, and many computer systems are not configured to reliably open electronic versions of such charts.

Accordingly, a need exists for a data structure that simplifies the development of an electronic chart. In addition, a need exists for a data structure that can be easily produced.

The disclosed embodiments are directed to solving one or more of the above problems.

### SUMMARY OF THE INVENTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It is also noted that as used herein and in the appended claims, the singular forms “a,” “an,” and “the” include plural references unless the context clearly dictates otherwise. Thus, for example, reference to a “text” is a reference to one or more texts and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

In an embodiment, a data structure for defining a chart is hereinafter disclosed. The data structure resides on a computer-readable medium and comprises: a graphing module configured to received formatted data and operate on the formatted data to generate the chart; a properties section, wherein the properties section comprises a size tag for defining height and width of the chart, a chart area tag for defining plotting area of the chart, an axes tag for defining independent and dependent axes of the chart, and a style tag; and a chart section, wherein the chart section comprises a point tag, a group tag for defining grouping properties of bars, a stack tag for defining stacking properties of bars, and a bar tag for holding data values.

In addition, a method for defining a chart is disclosed herein. The method comprises defining a data structure, wherein the data structure comprises: a graphing module configured to received formatted data and operate on the formatted data to generate the chart; a properties section, wherein the properties section comprises a size tag for defining height and width of the chart, a chart area tag for defining plotting area of the chart, an axes tag for defining independent and dependent axes of the chart, and a style tag; and a chart section, wherein the chart section comprises a point tag, a group tag for defining grouping properties of bars, a stack tag for defining stacking properties of bars, and a bar tag for holding data values; and wherein the data structure resides on a computer-readable medium.

Other data structures and methods of defining a chart may also be performed within the scope of this disclosure.

### BRIEF DESCRIPTION OF THE DRAWINGS

Aspects, features, benefits and advantages of the embodiments described herein will be apparent with regard to the following description, appended claims and accompanying drawings where:

FIG. 1 illustrates various embodiments of graphing module;

FIG. 2 illustrates various embodiments of a data structure utilized to define a chart;

FIG. 3 illustrates various embodiments of a graph template;

FIGS. 4A through 9A illustrates various embodiments of the data structure of FIG. 2;

FIGS. 4B through 9B illustrate graphs generated by the data structures of FIGS. 3A through 9A; and

FIGS. 10 through 25 illustrate examples of charts produced by various embodiments of the data structure of FIG. 2.

### DETAILED DESCRIPTION OF THE INVENTION

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

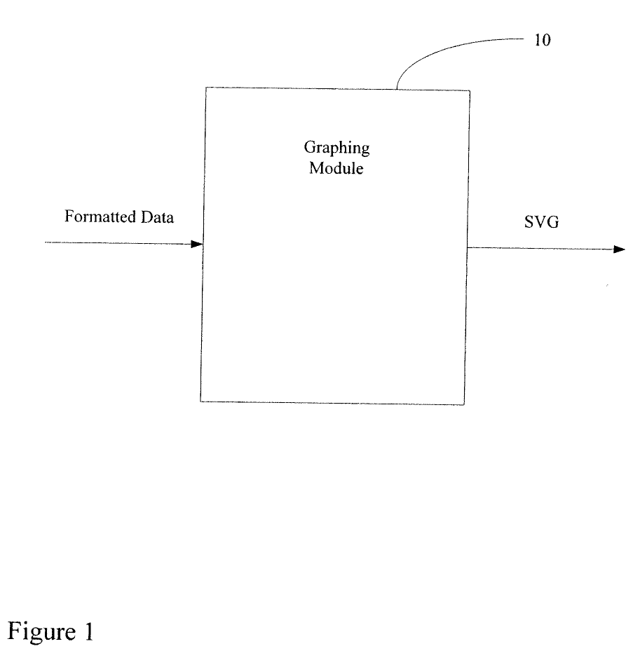

FIG. 1 illustrates various embodiments of a graphing module 10. The graphing module 10 is structured and arranged to receive formatted data, and operate on the formatted data to generate a chart. According to various embodiments, the formatted data may be represented as an extensible markup language, and the chart may be generated with scalable vector graphics (SVG). According to other embodiments, the chart may be generated with other types of code. The chart may be any type of chart (e.g., a graph, a bar chart, a scatter plot, etc.).

The graphing module 10 may be implemented in software, hardware, or firmware, and may comprise a portion of a computing device. According to various embodiments, the graphing module 10 may be implemented as a software application, a computer program, etc. utilizing any suitable computer language (e.g., C, C++, Delphi, Java, JavaScript, Perl, Visual Basic, VBScript, etc.) and may be embodied permanently or temporarily in any type of machine, component, physical or virtual equipment, storage medium, or propagated signal capable of delivering instructions to a device. The software code may be stored as a series of instructions or commands on a computer-readable medium such that when a processor reads the medium, the functions described herein are performed.

As used herein, the term “computer-readable medium” may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more propagated signals, and such propagated signals may or may not be transmitted on one or more carrier waves. Although the graphing module 10 is shown in FIG. 1 as a single module, one skilled in the art will appreciate that the functionality of the graphing module 10 may be distributed across any number of modules. According to various embodiments, such modules may be installed on separate, distinct systems. Also, different functional aspects of such modules may be installed on separate, distinct devices.

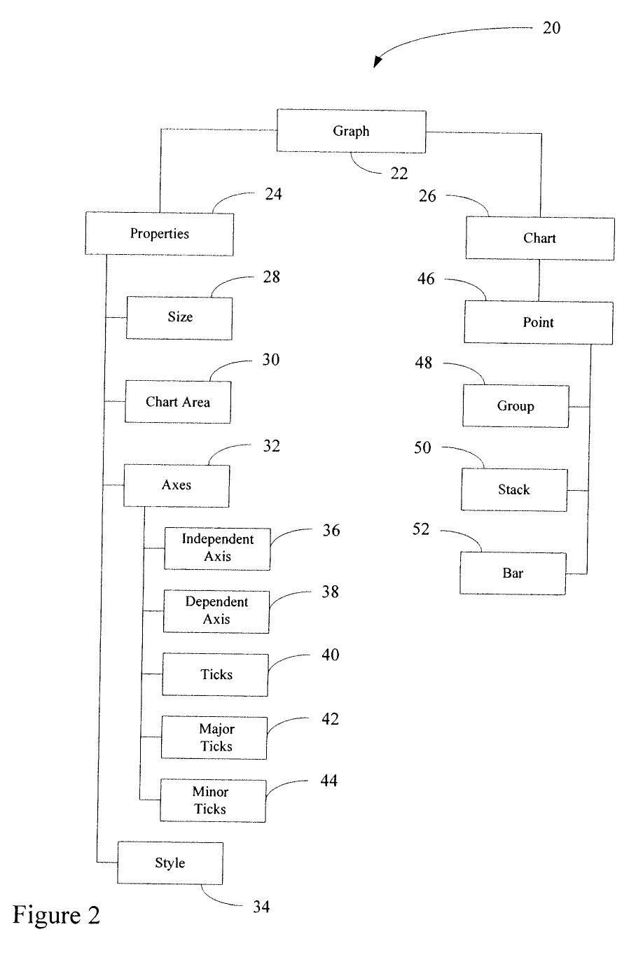

FIG. 2 illustrates various embodiments of a data structure 20 for defining a chart. The chart may be any type of chart (e.g., a graph, a bar chart, a scatter plot, etc.), may be generated by the graphing module 10 of FIG. 1, and may be defined in an xml format with a schema comprising a root tag and two children tags. For the data structure 20 shown in FIG. 2, the graph tag 22 (e.g., <graph>) is the root tag, the properties tag 24 (e.g., <properties>) is one child tag, and the chart tag 26 (e.g., <chart>) is the other child tag. Thus, the data structure 20 comprises two core sections, a properties section and a chart section. Of course, one skilled in the art will appreciate that the data structure 20 may comprise additional sections. For example, the data structure 20 may also comprise title sections, footnote sections, disclaimer sections, etc. which define how to display titles, footnotes and disclaimers if provided.

In general, any part of the chart that is not related to the chart data point can be defined by the properties section. The properties section may comprise a size tag 28 (e.g., <size>), a chart area tag 30 (e.g., <chartarea>), an axes tag 32 (e.g., <axes>), and a style tag 34 (e.g., <style>). The size tag 28 defines the overall height and width of the chart. The chart area tag 30 defines the plotting area of the chart.

The axes tag 32 defines the independent and dependent axes of the chart. The properties section may also comprise tags which descend from the axes tag 32. For example, the properties section may comprise an independent axis tag 36 (e.g., <independent thickness>) for defining the thickness of the independent axis, a dependent axis tag 38 (e.g., <dependent thickness>) for defining the thickness of the dependent axis, a ticks tag 40 (e.g., <ticks>) for defining the respective major and minor tick lengths, a major ticks tag 42 (e.g., <major ticks>) for defining grids and increments associated with the major ticks, a minor ticks tag 44 (e.g., <minor ticks>) for defining grids and increments associated with the minor ticks, etc. Thus, the properties section may define the height and width of the chart, the axes, the plotting area, axis and tick mark dimensions, increment spacing, actual pixel sizes, etc. According to various embodiments, plotting and sizing may be done with relative values and percentages. Certain components like tick marks, grid lines, and axes may be defined to toggle on or off.

The style tag 34 defines the styles for areas (e.g., rectangles) behind the entire SVG and the plotting area, the style of all bars, the alignment of all groups and stacks, and provides a mechanism for styling the bars via some pattern. In general, there are two rectangles, one for the whole chart, and one for the plotting area. Each rectangle has class and style attributes.

The chart section comprises data points, and tags to define how to group and plot the data points. The chart section comprises a point tag 46 (e.g., <point>), a group tag 48 (e.g., <group>), a stack tag 50 (e.g., <stack>), and a bar tag 52 (e.g., <bar>). The point tags 46 are the only children of the chart tag 26, and are parents to the group tags 48 and stack tags 50. Each point may house a single bar, a group, a stack, a group of stacks, or may be empty. In addition, each chart may have different types of bars. For example, a given chart may have a two-bar stack and a group of single bars. The group tags 48 define grouping properties of bars, and the stack tags 50 define stacking properties of bars. The bar tags 52 hold the actual data values.

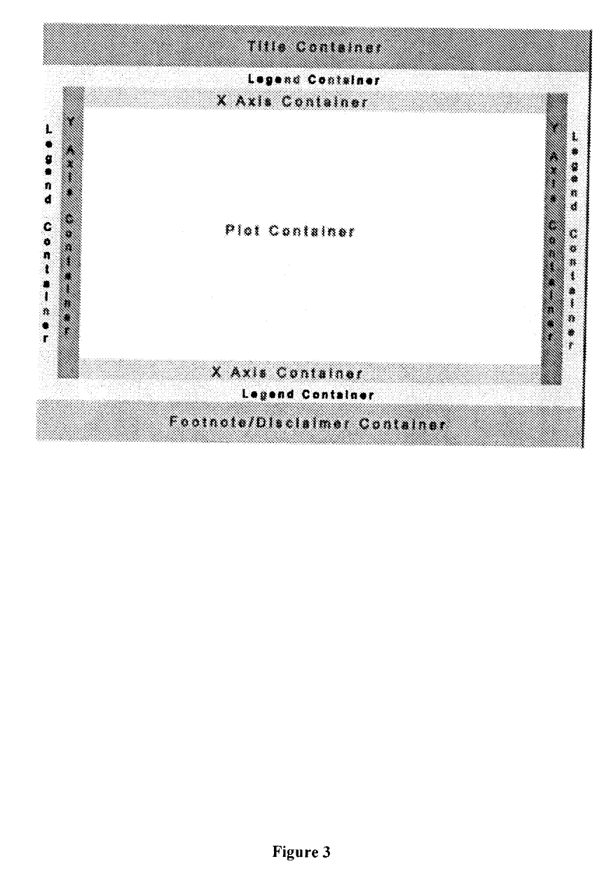

FIG. 3 illustrates various embodiments of a graph template 60. The template 60 may be divided into a first layer and a second layer. The first layer may comprise a title portion, a legend portion, and a footnote/disclaimer portion. Collectively, the portions may define a large rectangle. The second layer is smaller than the first layer, and comprises a plot portion, an x-axis portion, and a y-axis portion. The second layer may be resizable and rearrangeable within the legend portion. The x-axis portion and the y-axis portion may sit on top of the plot portion. The styles, color, opacity, etc. may be set with a CSS style statement or a CSS class on the chart tag 26 and the chart area tag 30 under the style tag 34.

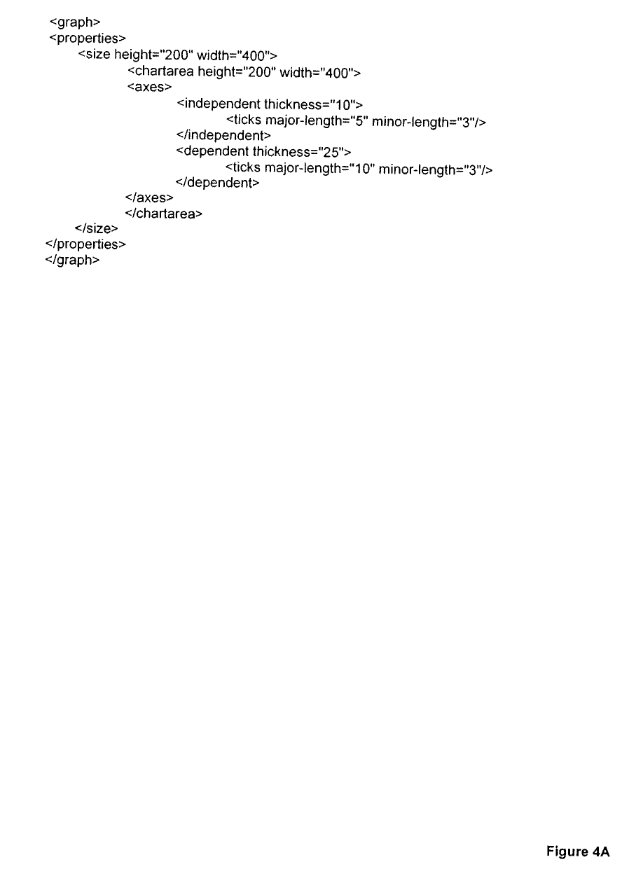

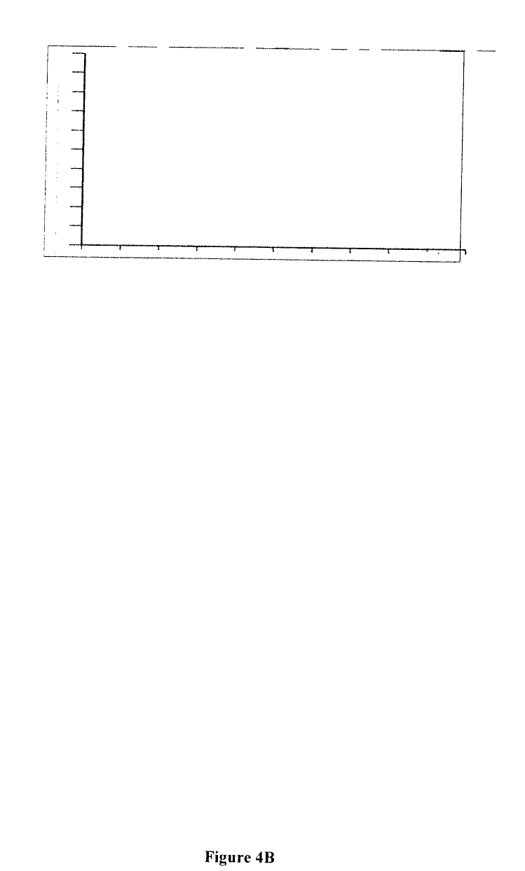

FIGS. 4A, 5A, 6A, 7A, 8A and 9A illustrate various embodiments of the data structure 20, and FIGS. 4B, 5B, 6B, 7B, 8B and 9B illustrate graphs generated using the respective embodiments of the data structure 20. For example, the graph illustrated in FIG. 4B is generated using the data structure 20 of FIG. 4A. With respect to the graph illustrated in FIG. 4B, the graph is 200 points high by 400 points wide, and the chart area comprises the entire graph. The independent axis, by default, is shown as the x-axis. The dependent axis, by default, is shown as the y-axis. The major ticks associated with the x and y axes are shown with three points and ten points, respectively.

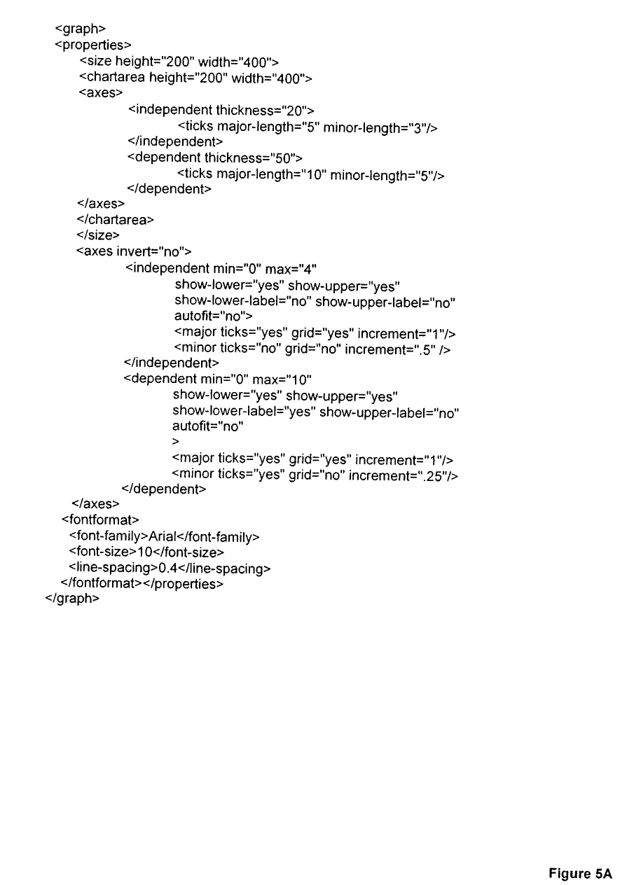

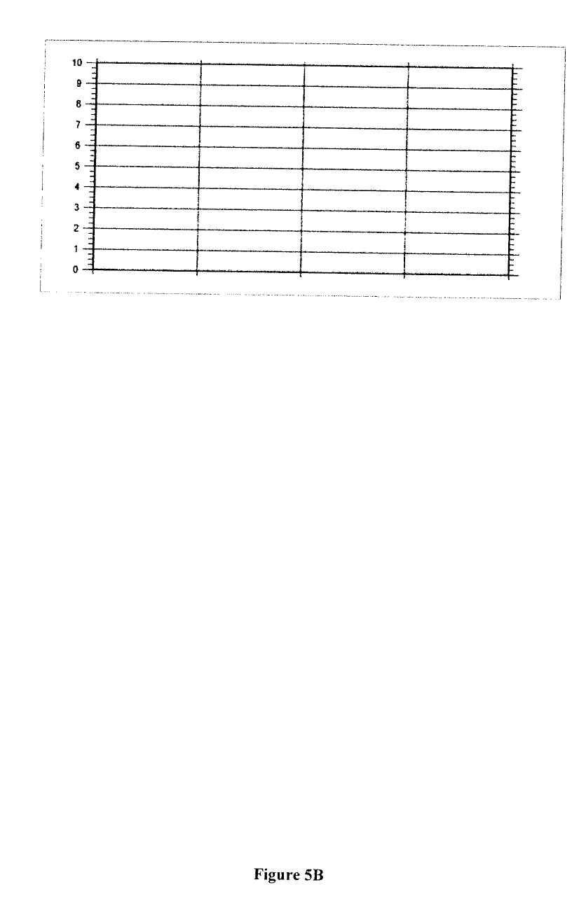

FIG. 5B is similar to FIG. 4B, but is different in that the range of the independent axis is from zero to four, both sides of the independent axis are shown, and major ticks and grid lines associated with the independent axis are shown. In addition, also shown in FIG. 5B are both sides of the dependent axis, major and minor ticks, grid lines, and labels (i.e., 0-10) associated with the dependent axis. By having the thickness of the dependent axis set to 50 points, adequate space is provided for the labels.

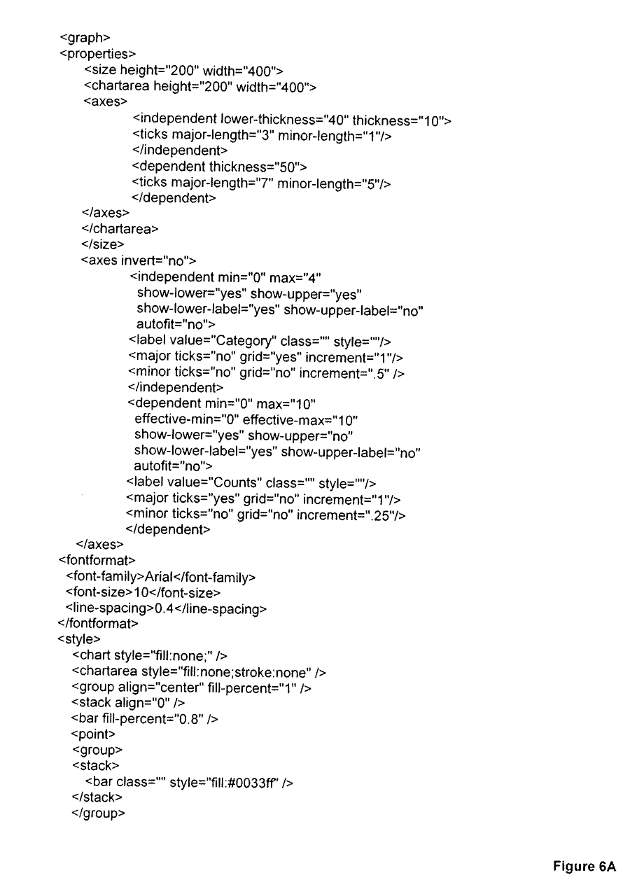

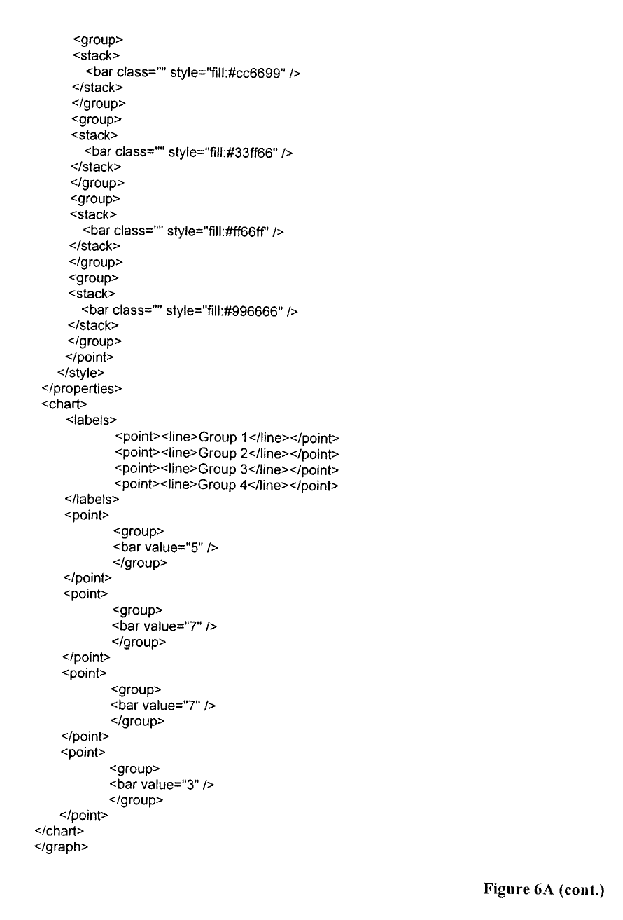

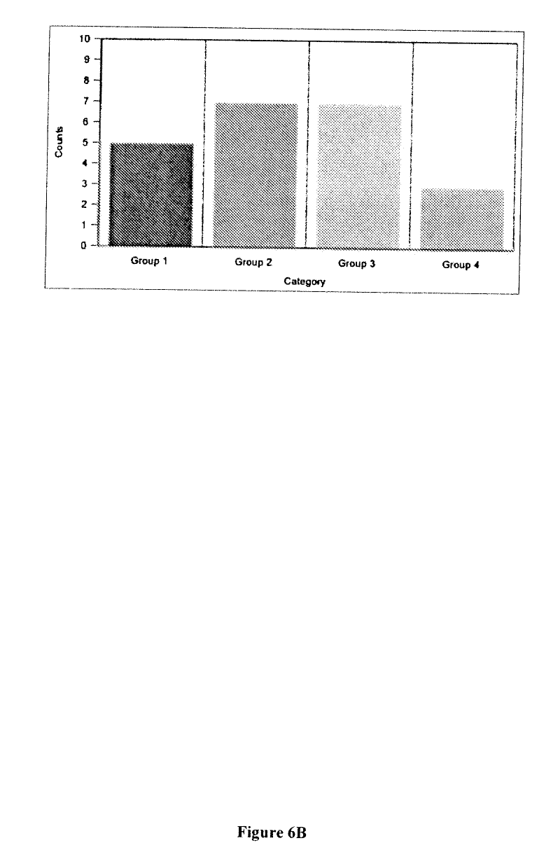

With respect to the graph illustrated in FIG. 6B, the graph is 200 points high by 400 points wide, and the chart area comprises the entire graph. The independent axis is labeled as “Category” and is shown as the x-axis. The dependent axis is labeled as “Counts” and is shown as the y-axis. The range of the independent axis is from zero to four, and each independent axis does not show any major ticks or minor ticks. Only grid lines associated with the major ticks along the independent axis are shown. The range of the dependent axis is from zero to ten, and the left dependent axis shows major ticks and labels. The chart shows four bars, where each bar is a different color, and each bar is centered with respect to the given increment. A label (e.g., Group 1, Group 2, etc.) is shown for each bar.

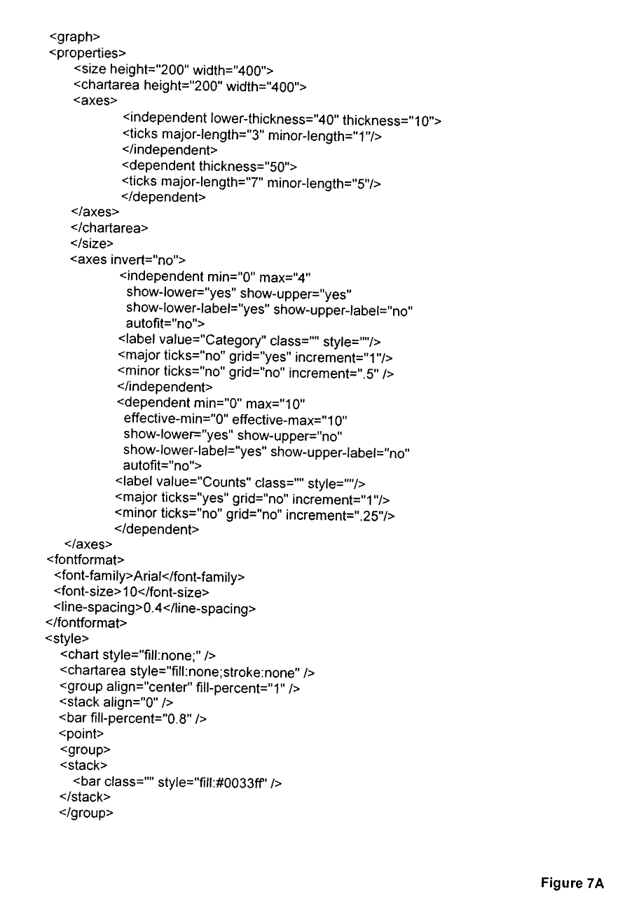

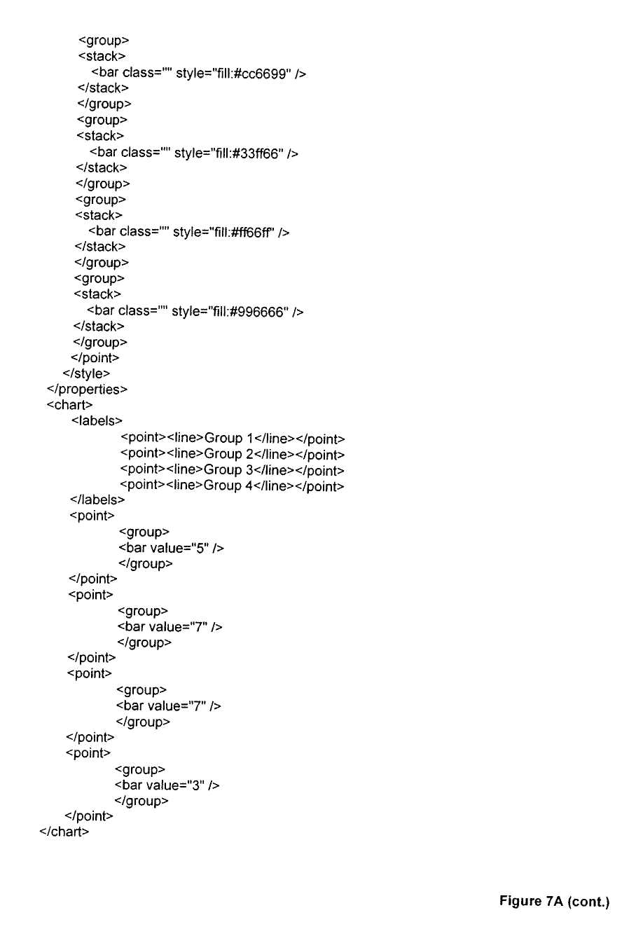

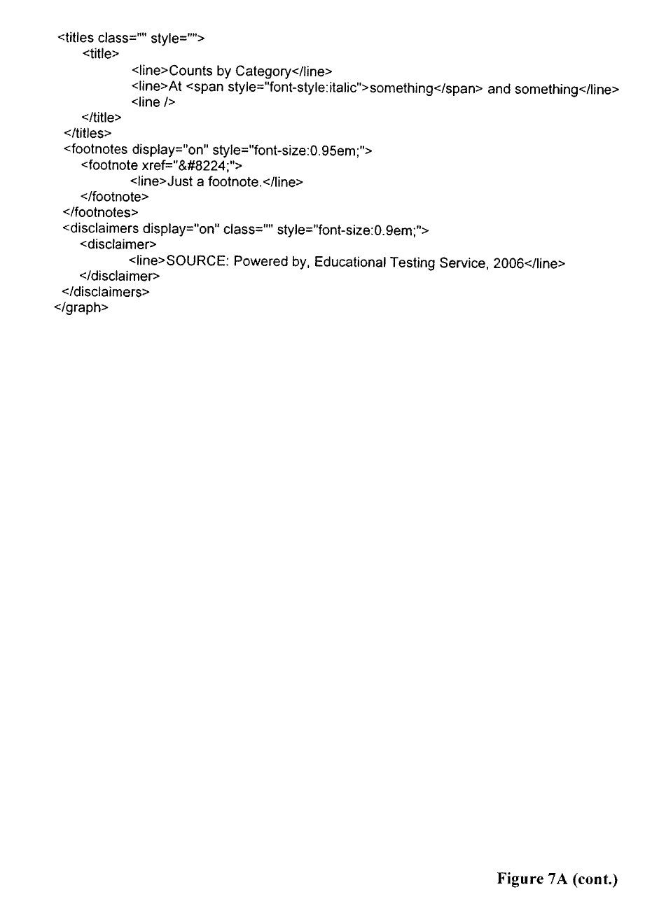

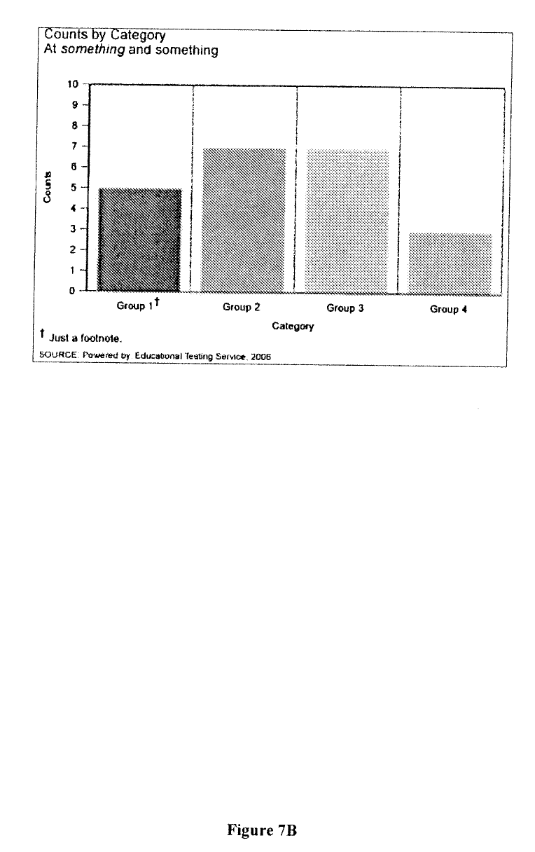

FIG. 7B is similar to FIG. 6B, but is different in that a title, a footnote, and a disclaimer are shown. As shown in FIG. 7B, the title may comprise a mix of various fonts, the footnote may comprise a superscript along with the text, and the disclaimer may comprise a mix of various font sizes. One skilled in the art will appreciate that any defined label may comprise a mix of various fonts, and any area of the graph may comprise a mix of various font sizes.

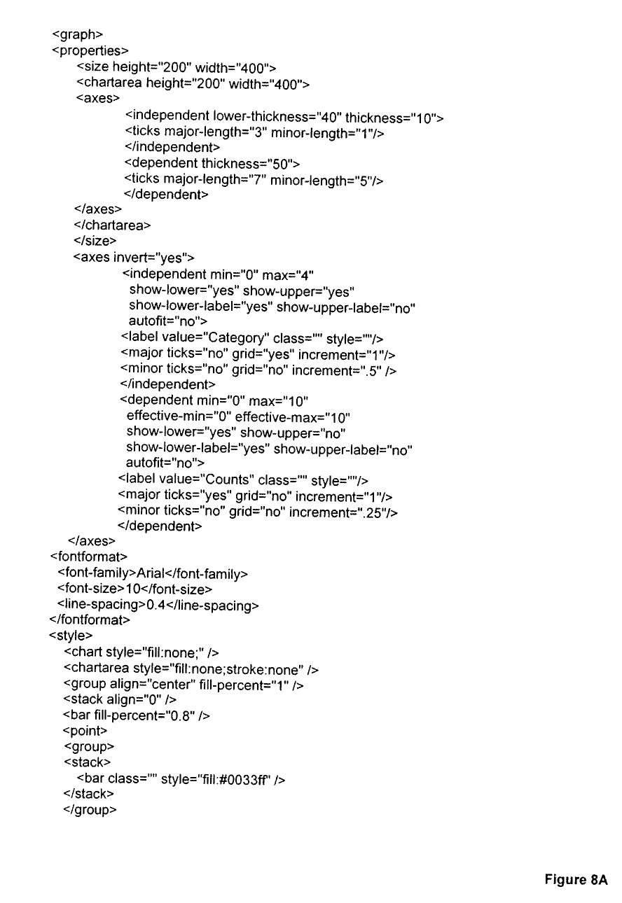

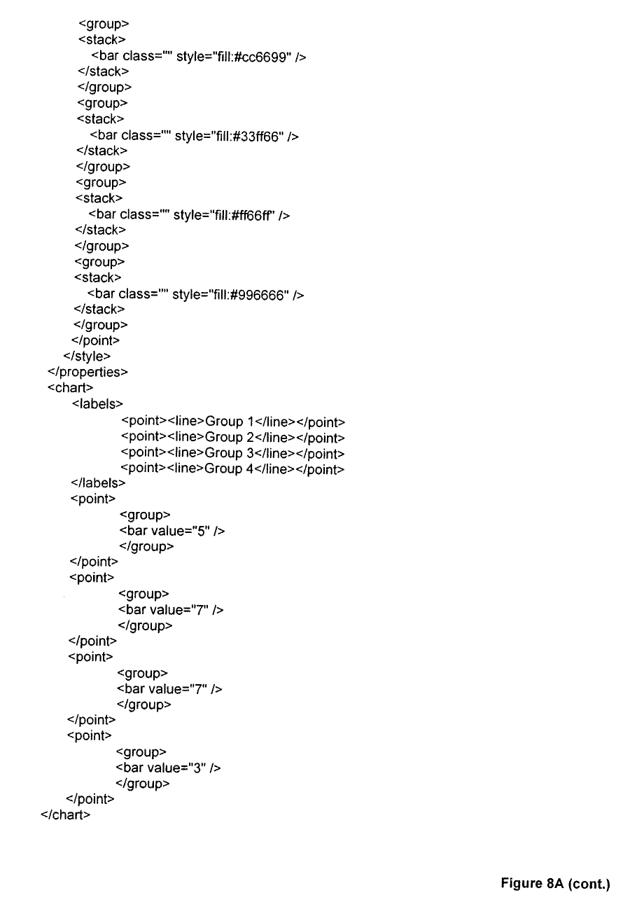

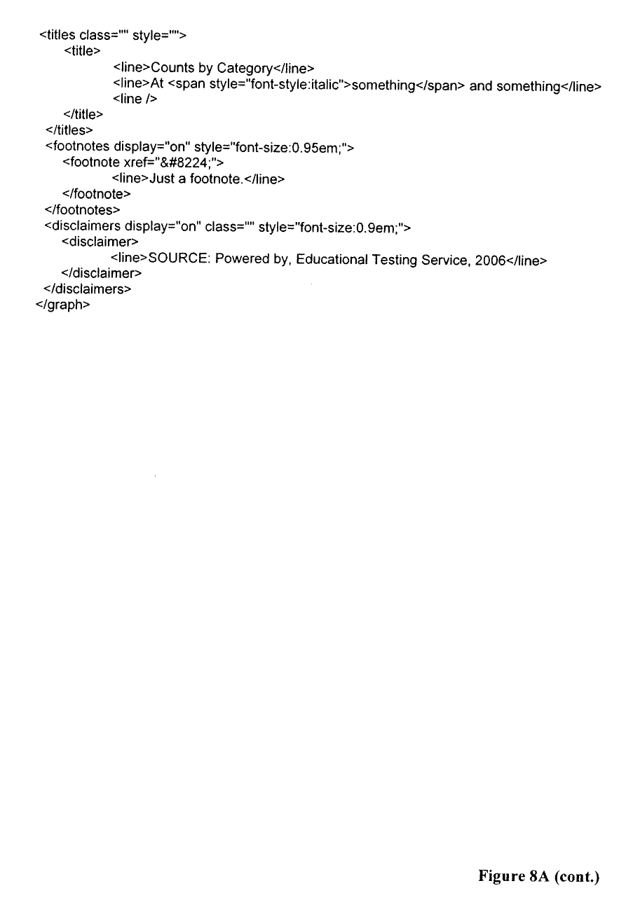

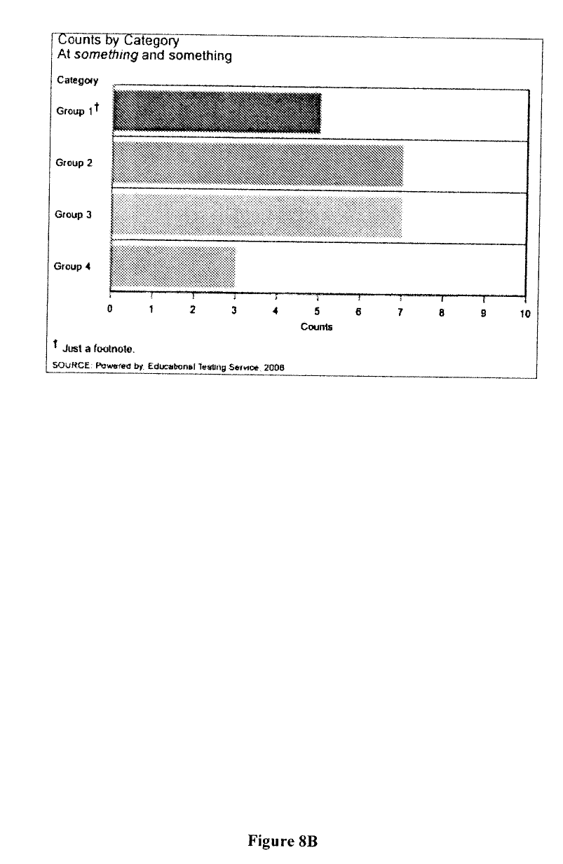

FIG. 8B is similar to FIG. 7B, but is different in that the independent axis and the dependent axis, and the information associated therewith, have been inverted (i.e., rotated by 90°). As shown in FIG. 8B, the title, footnote and disclaimer sections of the graph are not affected by the inverting of the axes.

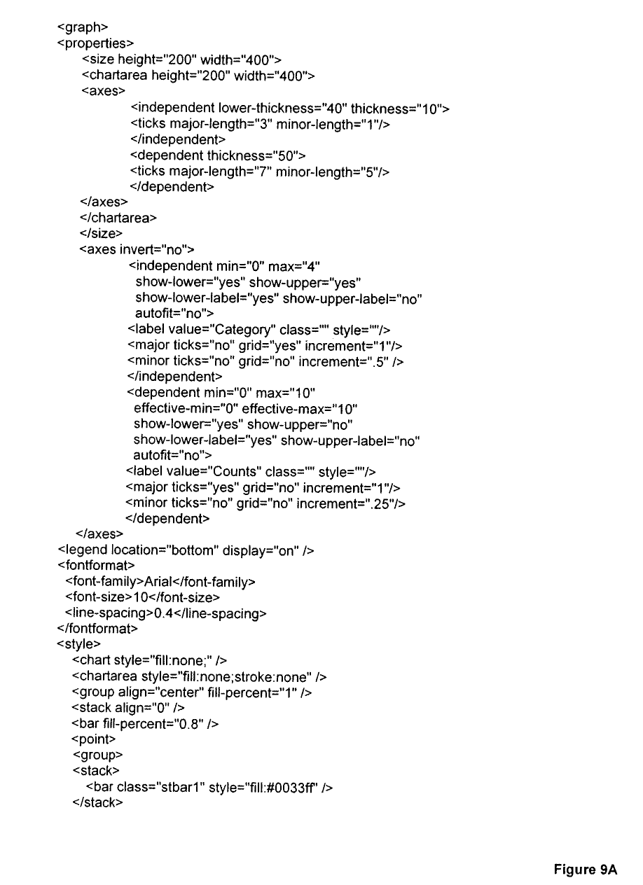

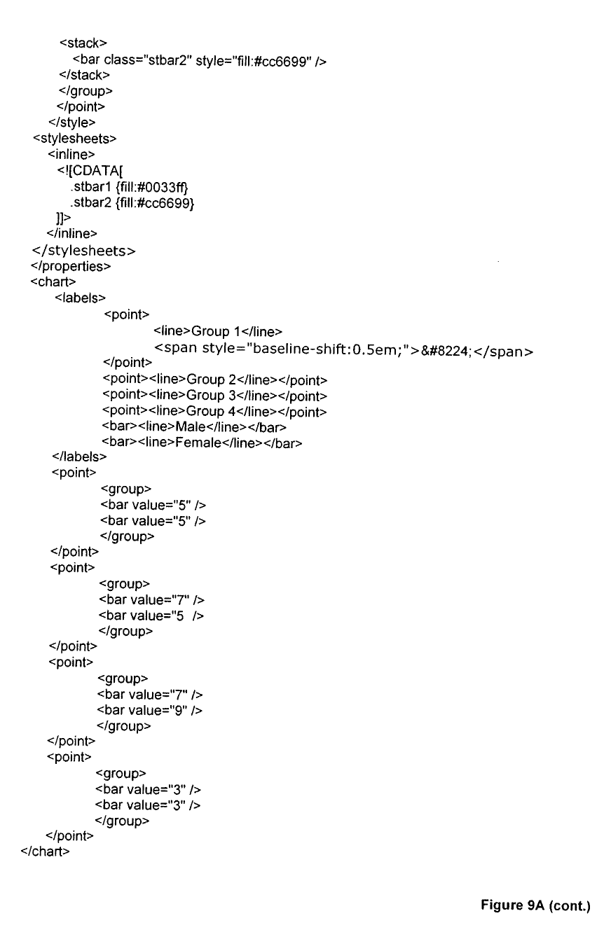

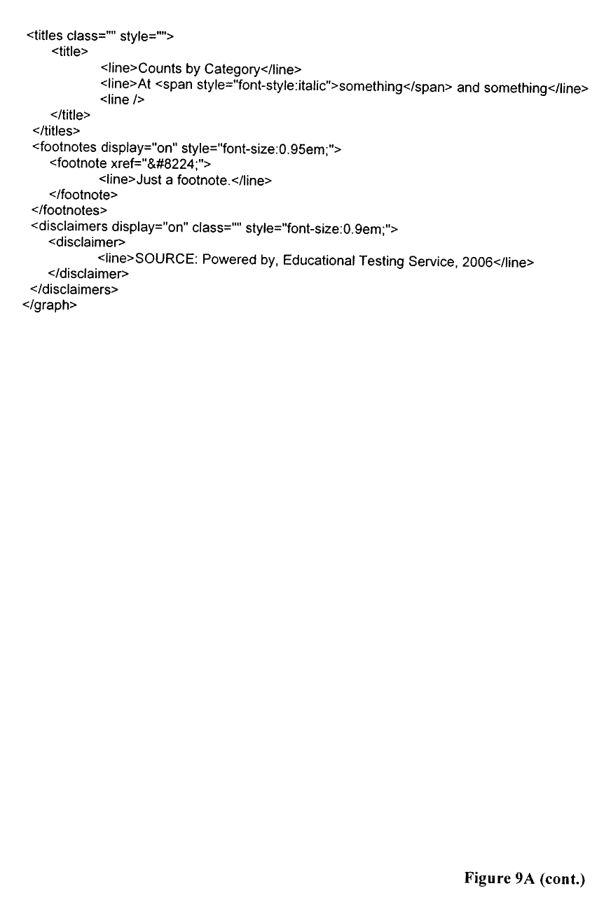

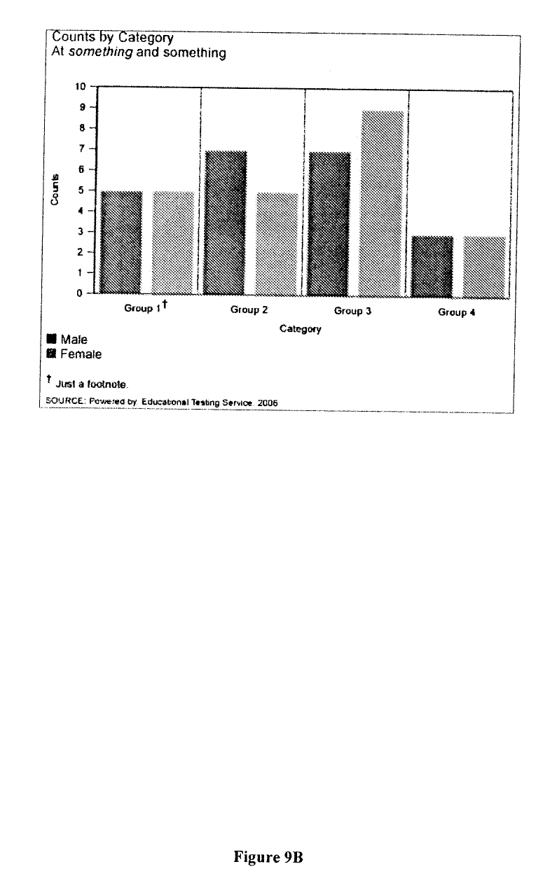

FIG. 9B is also similar to FIG. 7B, but is different in that the data structure 20 of FIG. 9A is configured to generate a cluster bar chart, where bars representing male and female are shown for each of groups 1-4.

From the foregoing, one skilled in the art will appreciate that the data structure 20 allows for the height or width of a given chart to be to set at three different levels: the chart, the plotting area, and the pixel size of one point on an axis. A liberate attribute may be utilized to remove height and width attributes from the resulting SVG document while preserving the aspect ratio. Thus, the size of the chart may be set externally.

The overall chart size is the parent of the plotting area, which is the parent of the pixel size of one point for each axis. By setting one of the size, the chart area, and the axes, the other two may be automatically determined. For example, when the overall chart size is set, the plotting area is determined, and the plotting area is used to determine the size of one point of an axis. When the plotting area is set, it is used to determine the overall chart size, and the pixel size of one point can be determined using the range defined in the axes properties. With respect to the axes, the pixel size of a point can be set for the independent axis, the dependent axis, or both. Depending on whether the independent axis is horizontal or vertical, the plotting area width is set by taking the range of the independent (or dependent) axis and multiplying by the pixel size of a point. The overall chart size can then be determined from the plotting size area.

With respect to a given bar, each group has a certain width, and within a group, the bars have a certain width. The spacing of the bars in the group is related to the width of the group, and bars within a group may have space between them. Only one actual pixel setting is needed to plot groups and bars, and the bar widths may be controlled with percentages. There are two percentages which may control the widths of the bars: the fill-percent of the group, and the fill-percent of the bar. Both fill-percentages may be set globally in the style tag 34 or on specific point tags 46. The group fill percentage may define what percent of the group's full thickness is to be used when drawing the groups. The effective width of a group may be determined by multiplying the full thickness by the group fill percentage. The bar fill percentage may be determined by dividing the effective thickness of the group by the maximum number of bars in the group.

With respect to the axes, the axes tag 32 may define the scale of each axis by providing a minimum and a maximum, may allow for breaks in the scale at the ends, and may set the spacing and styling of major ticks, minor ticks, and grid lines. Thus, each axis may have a minimum and a maximum between which data is plotted. Every point on an axis may correspond to a data point, even the independent axis. The data points may be mapped by computing the ratio that converts data points to actual pixel values by dividing the length of an axis by the range of points. If the effective minimum or maximum is set, it may be used to delineate the points that may be plotted on the axis, and a break symbol may be placed between the effective minimum (or maximum) and the real minimum (or maximum). If an axis is positive or negative infinite, an arrow symbol placed at the appropriate end of the axis may be utilized to illustrate this. The axes tag 32 may also set which axes will be displayed, and may permit reference lines to be drawn. For example, it is often desirable to draw a line across the plotting area arbitrarily, to show cut scores for instance. The reference line tags define these lines for each axis. A point on the axis is specified and class and styles can be set. The lines go over and through the bars. According to various embodiments, the independent and dependent axis may have exactly the same attributes and tag hierarchy.

Each axis line may have evenly spaced major and minor tick marks and grid lines. Tick marks are drawn starting from the effective minimum up to the effective maximum divided by the tick mark increment. For the major tick marks, if the effective maximum tick mark increment is not zero, a tick mark may be placed at the effective maximum. Major and minor grid lines may be drawn using a process similar to that used for the major and minor tick marks. However, the major and minor grid lines may cross the plotting area and may be covered by the bars.

With respect to breaks, when the effective maximum (or minimum) is greater than (or less than) the minimum (or the maximum), space for a break symbol may be made and a standard or user-defined break symbol may be drawn. According to various embodiments, no data may be represented for data outside the effective minimum and maximum. However, a bar may be drawn through the dependent axis minimum break if the points which comprise the bar are on the dependent minimum or below. If a bar starts inside the break but reaches the inside of the effective range, the bar may be drawn starting from the effective minimum.

In general, there are two different alignments associated with bars: group and stack. The group alignment defines where the group will be placed in relationship to the point. For example, “center” may center the group on the point, “before” may position the group before the point (e.g., causing the end of the group to be flush with the point, and “after” may position the group after the point. The stack alignment may define how many bars will be negative to the point. For example, if there is a stack of three bars at point (0,0) and an alignment of two, only the last bar in the stack will start from (0,0) and extend positively. The other two bars of the stack will be negative to the point. According to various embodiments, the order of the stack is always preserved. Group alignment may be thought of as aligning along the independent axis and stack alignment may be thought of as aligning along the dependent axis.

With respect to bar styles, even if there are no grouped or stacked bars, group tags 48 and stack tags 50 may still be present in the data structure 20. A group with one child (stack or bar) is a single stack or bar. A stack with one bar is just a regular single bar. In general, bars are drawn by specifying the point at which to start, and the value or length of the bar. The bar tag 52 holds the actual data value. To plot one or more bars, points are placed evenly separated at regular intervals which can be set in the axes tag 32. Points can be explicit places with x and y attributes on the point tag 46 where x is the independent axis and y is the dependent axis. A point may be empty, or may house a single bar, a stack of bars, or a group of stacks. A chart may have different bar types. For example, a chart may have a single bar, a stack of bars, a group of single bars, a group of stacked bars, or any combination thereof.

Each point tag 46 may define an “x” attribute and a “y” attribute. The “x” attribute is a number on the independent axis of the chart and the “y” attribute is a number on the dependent axis of the chart. According to various embodiments, a default value for the “x” attribute or the “y” attribute may be automatically determined.

Each group tag 48 may define an “align” attribute and a “fill-percent” attribute. The “align” attribute may define whether the particular group is centered on the chart, or is positioned before or after another group on the chart. The “fill-percent” attribute may define the percentage of the group's full thickness to be allocated to the bars in the group.

Each stack tag 50 may define an “align” attribute. The “align” attribute may define the number of bars in the stack. The “align” attribute may hold an integer value from 0 to n, where n−1 is the number of bars in the stack.

Each bar tag 52 may define a “value” attribute, a “fill-percent” attribute, and an “align” attribute. The “value” attribute holds a data value for the bar, and the data value may be translated to a length on the chart. The “fill-percent” attribute defines how wide the bar should be as a percentage of its full width as determined from a group width. The “align” attribute is similar to the “align” attribute of the group tag, and is only used when there is no group ancestor for the bar.

According to various embodiments, many portions of the chart may accept styling information in the form of CSS styles. Each portion which may be styled has both a style attribute and a class attribute. The attributes correspond exactly to the style and class attributes on various SVG tags. The axes tag 32 may allow for styles to be defined on several things. For example, styles may be defined on the actual axis line (line-style and line-class), on the rectangle that contains the tick marks (box-style and box-class), on the tick marks (tick-style and tick-class), on the gridlines (grid-style and grid-class), on reference lines, etc. With respect to bar styles, overall and patterned styles can be set with class and style attributes in the style tag 34. Individual bar styles can be set, overriding the general and pattern styles but not cascading them, with the bar tags 52.

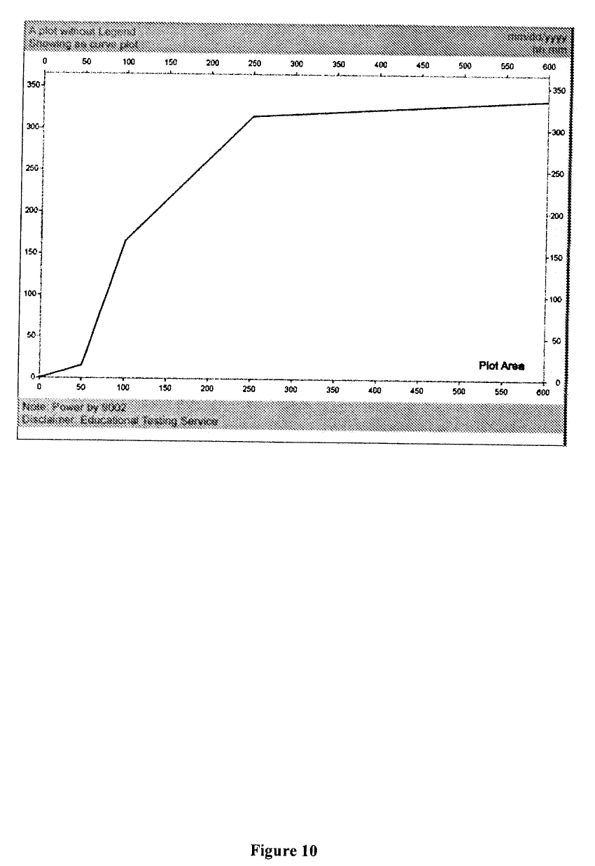

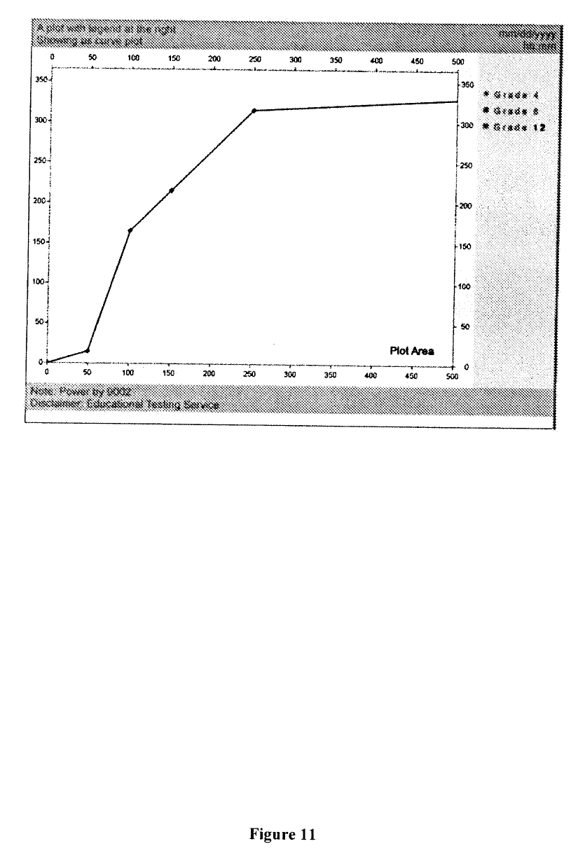

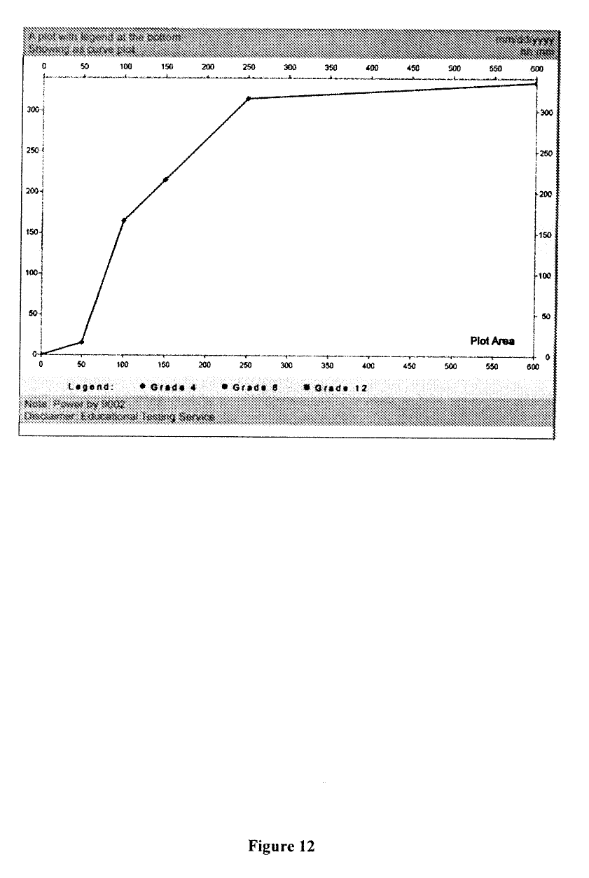

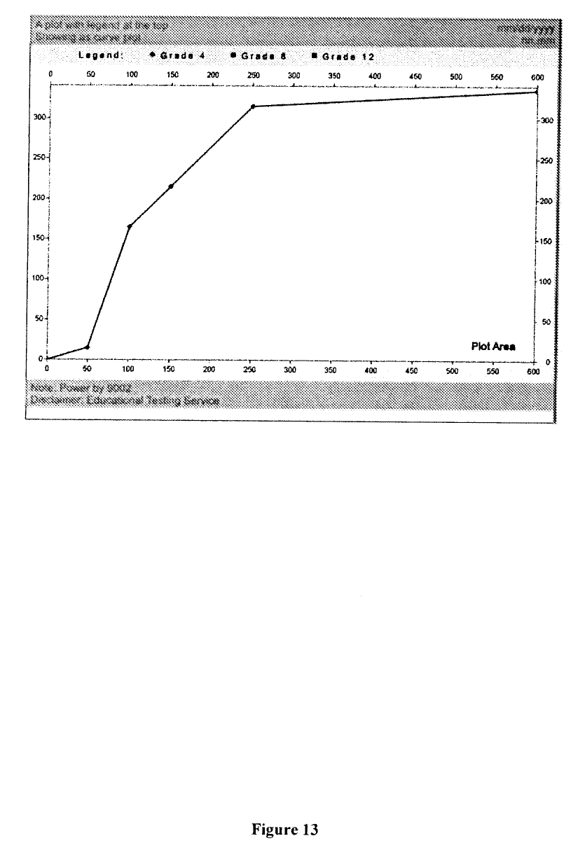

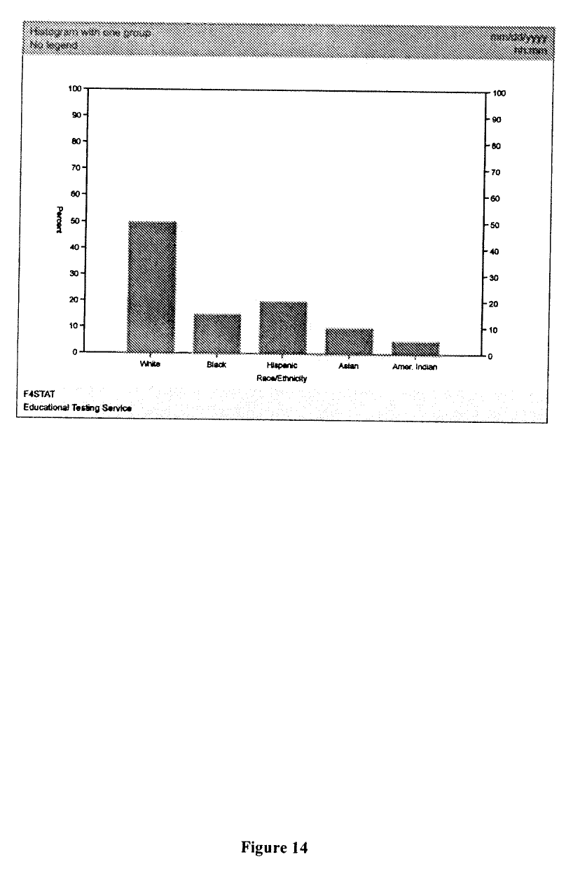

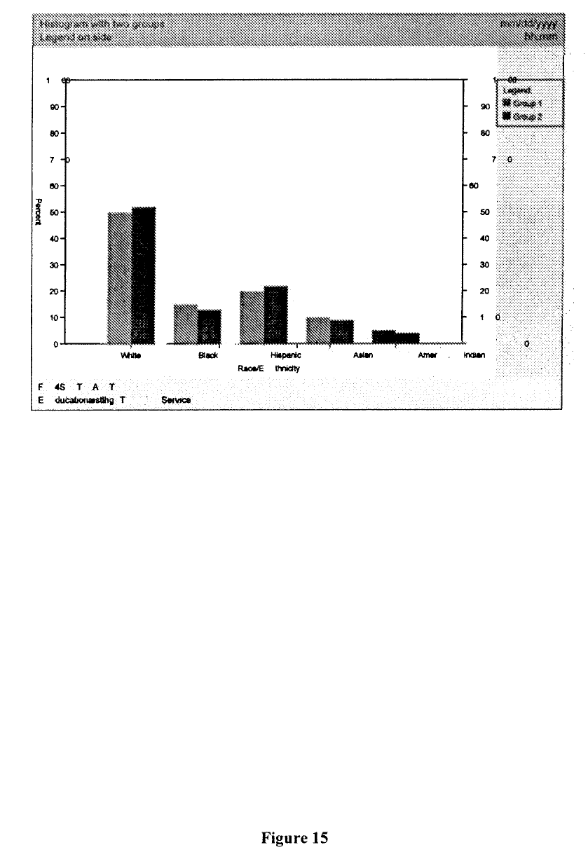

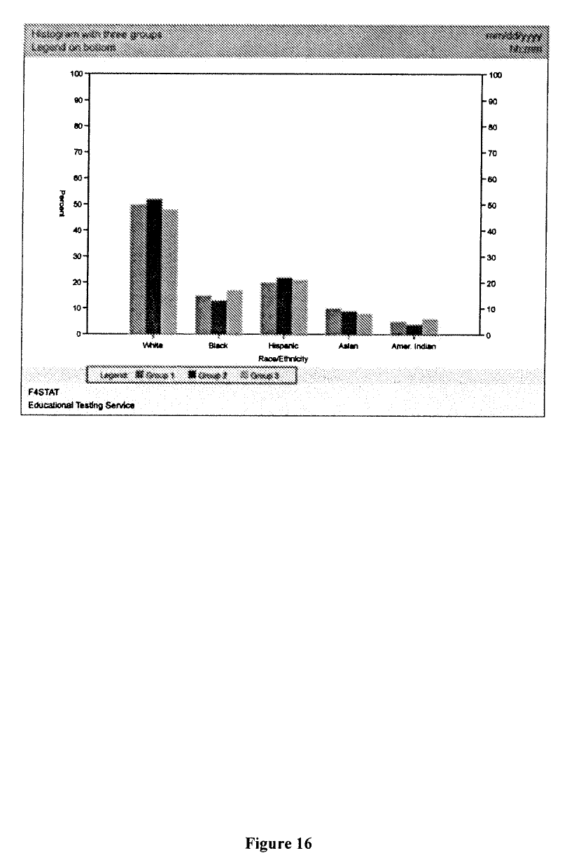

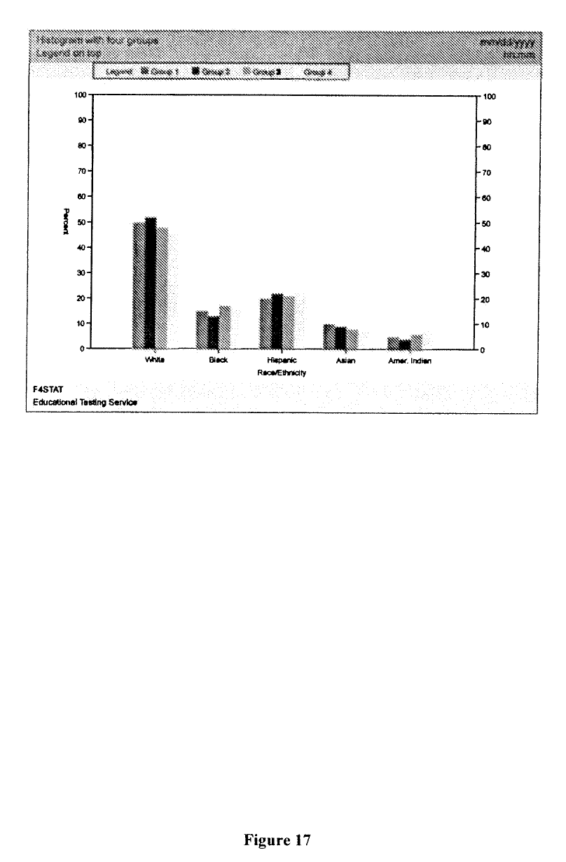

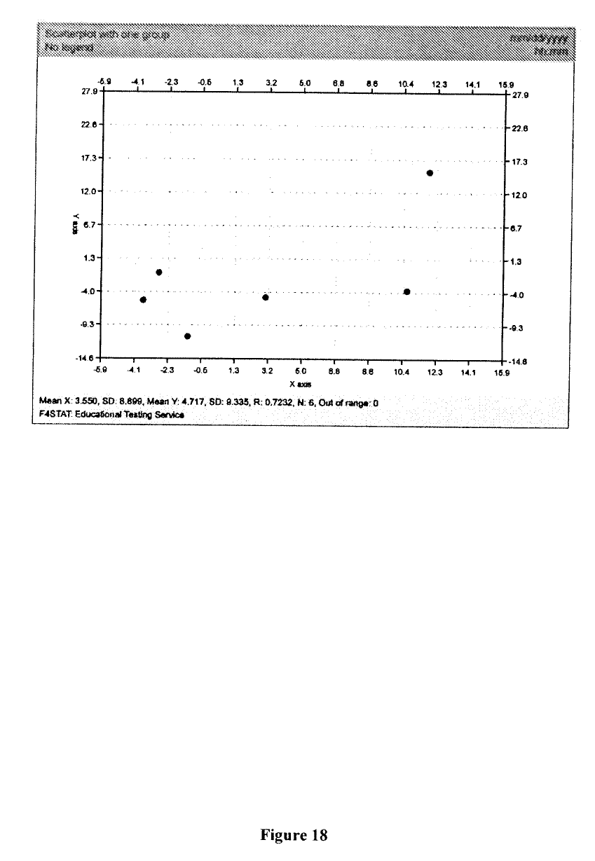

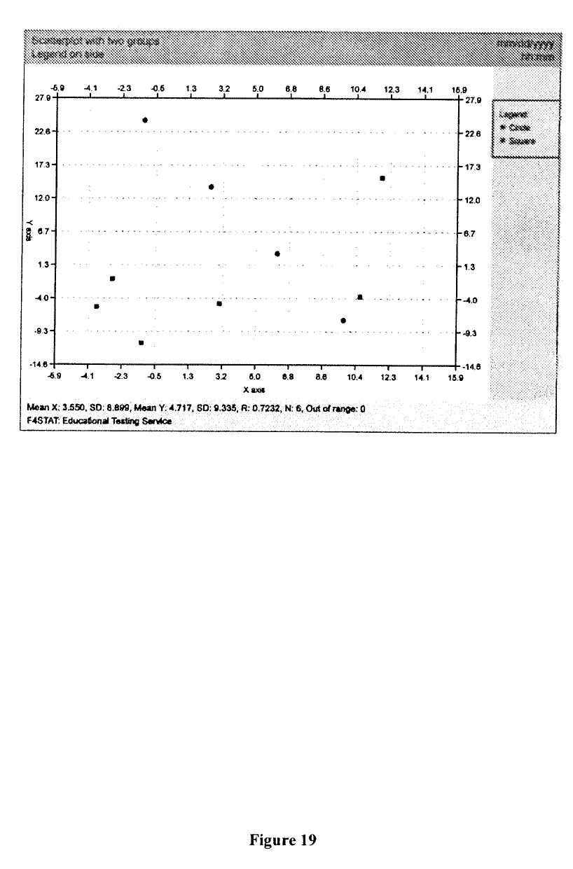

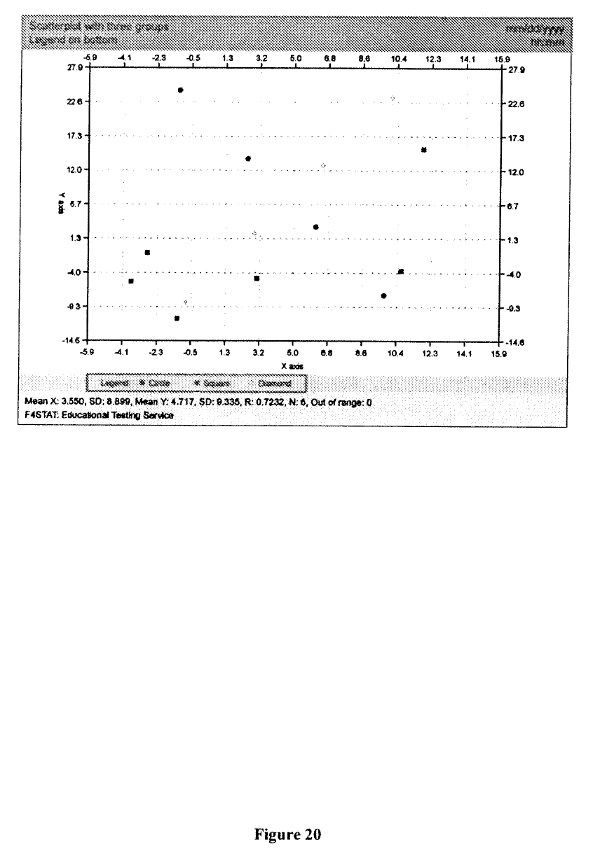

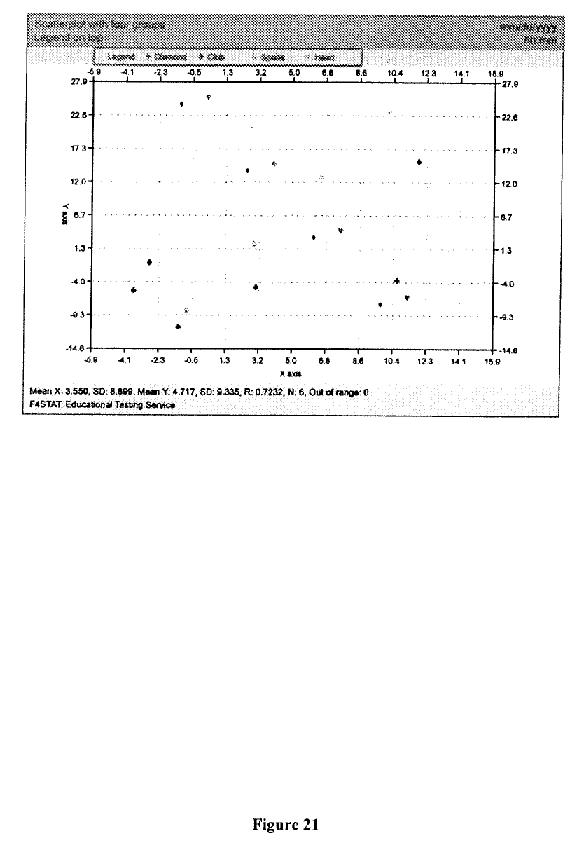

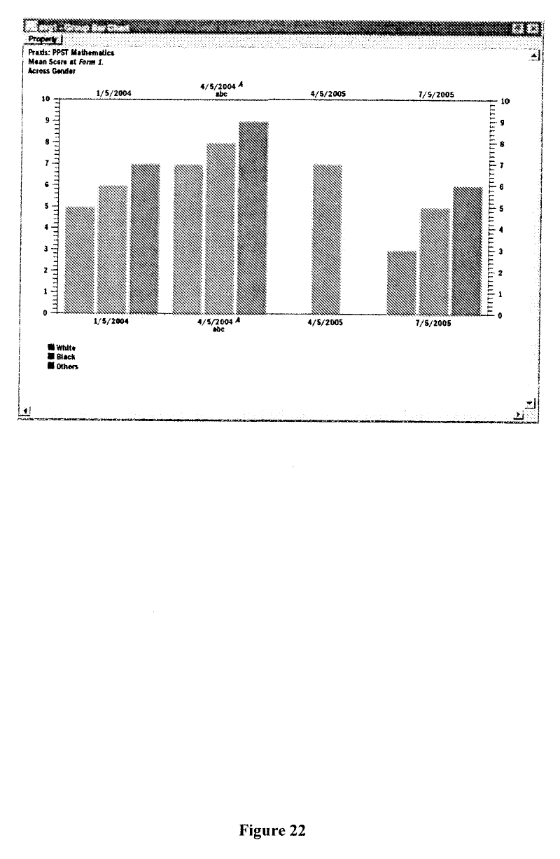

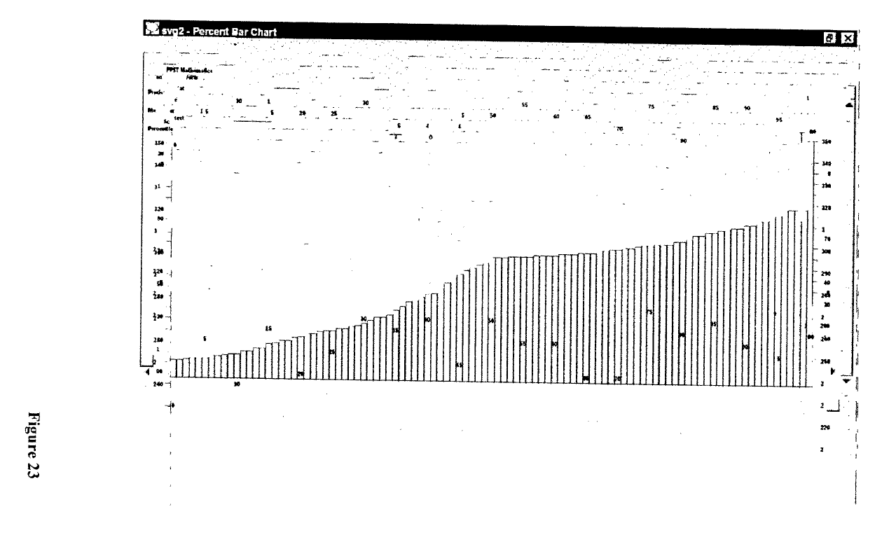

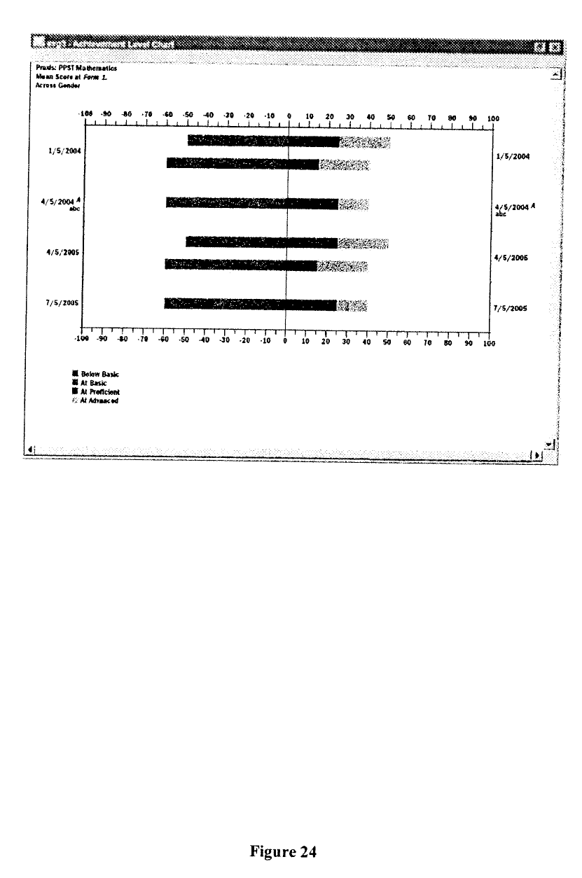

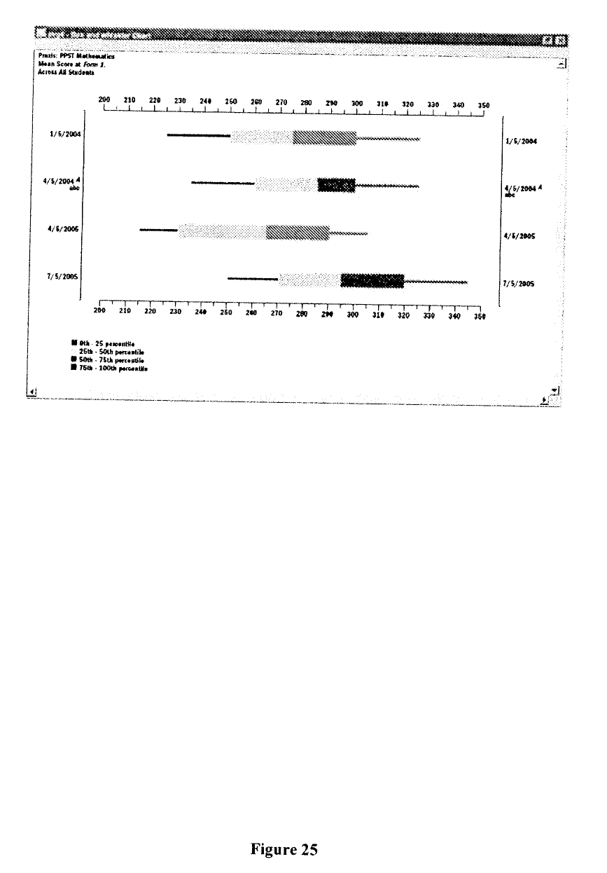

FIGS. 10-25 illustrate examples of charts produced by various embodiments of the data structure 20 of FIG. 2. As shown, the respective charts may comprise lines, categories, points, bars, line bars, data dots, histobars, dots, symbols, text, etc.

While several embodiments of the invention have been described herein by way of example, those skilled in the art will appreciate that various modifications, alterations, and adaptations to the described embodiments may be realized without departing from the spirit and scope of the invention defined by the appended claims.

What is claimed is:

1. A data structure residing on a computer-readable medium for defining a chart, the data structure comprising:
a graphing module configured to received formatted data and operate on the formatted data to generate the chart;
a properties section, wherein the properties section comprises a size tag for defining height and width of the chart, a chart area tag for defining plotting area of the chart, an axes tag for defining independent and dependent axes of the chart, and a style tag; and
a chart section, wherein the chart section comprises a point tag, a group tag for defining grouping properties of bars, a stack tag for defining stacking properties of bars, and a bar tag for holding data values.

2. The data structure of claim 1, wherein the formatted data is represented as an extensible markup language and wherein the chart is generated with scalable vector graphics (SVG).

3. The data structure of claim 1, wherein the graphing module is in an xml format with a schema comprising a root tag and two children tags.

4. The data structure of claim 1, wherein the axes tag further defines the scale of the axes by providing a minimum and maximum between which the data is plotted.

5. The data structure of claim 1, wherein the point tag defines an x attribute as a number on the independent axis of the chart, and the y attribute as a number on the dependent axis of the chart.

6. The data structure of claim 5, wherein a default value for the x attribute and the y attribute is automatically determined.

7. The data structure of claim 1, wherein the group tag further defines an align attribute for defining whether a group is centered on the chart, and a fill-percent attribute for defining the percentage of the group's thickness to be allocated to bars in the group.

8. The data structure of claim 1, wherein the stack tag further defines an align attribute for defining the number of bars in the stack.

9. The data structure of claim 1, wherein the bar tag further defines a value attribute for holding a data value for the bar and a fill-percent attribute for defining how wide the bar should be as a percentage of its full width.

10. A method for defining a chart, the method comprising:
defining a data structure, wherein the data structure comprises:
a graphing module configured to received formatted data and operate on the formatted data to generate the chart;
a properties section, wherein the properties section comprises a size tag for defining height and width of the chart, a chart area tag for defining plotting area of the chart, an axes tag for defining independent and dependent axes of the chart, and a style tag; and
a chart section, wherein the chart section comprises a point tag, a group tag for defining grouping properties of bars, a stack tag for defining stacking properties of bars,
and a bar tag for holding data values;
and wherein the data structure resides on a computer-readable medium.

11. The method of claim 10, wherein the formatted data is represented as an extensible markup language and wherein the chart is generated with scalable vector graphics (SVG).

12. The method of claim 10, wherein the graphing module is in an xml format with a schema comprising a root tag and two children tags.

13. The method of claim 10, wherein the axes tag further defines the scale of the axes by providing a minimum and maximum between which the data is plotted.

14. The method of claim 10, wherein the point tag defines an x attribute as a number on the independent axis of the chart, and the y attribute as a number on the dependent axis of the chart.

15. The method of claim 14, wherein a default value for the x attribute and the y attribute is automatically determined.

16. The method of claim 10, wherein the group tag further defines an align attribute for defining whether a group is centered on the chart, and a fill-percent attribute for defining the percentage of the group's thickness to be allocated to bars in the group.

17. The method of claim 10, wherein the stack tag further defines an align attribute for defining the number of bars in the stack.

18. The method of claim 10, wherein the bar tag further defines a value attribute for holding a data value for the bar and a fill-percent attribute for defining how wide the bar should be as a percentage of its full width.
